(19) United States
(12) Patent Application Publication
(10) Pub. No.: US 2016/0091029 A1
(43) Pub. Date: Mar. 31, 2016

(54) OVERLOAD COUPLING

(71) Applicant: Siemens Aktiengesellschaft, 80333 Munchen (DE)

(72) Inventors: Andre Jansen, Borken (DE); Marcel Reidl, Vreden (DE); Günter Scheithauer, Vreden (DE)

(73) Assignee: Siemens Aktiengesellschaft, 80333 Munchen (DE)

(21) Appl. No.: 14/866,196

(22) Filed: Sep. 25, 2015

(30) Foreign Application Priority Data
Sep. 26, 2014 (EP) 14186651.7

(51) Int. Cl. F16D 7/02

(52) U.S. Cl. CPC F16D 7/021

(57) ABSTRACT

An electrically insulating overload coupling for a wind turbine generator includes a gear-side or generator-side hub having an axially oriented ring flange. A pipe made of an electrically insulating material and having an axial section with an annular circumferential sliding surface rests directly on a corresponding sliding surface of the ring flange, so that the pipe is rotatable in a torque-dependent manner in relation to the ring flange.

### CROSS-REFERENCES TO RELATED APPLICATIONS

This application claims the priority of European Patent Application, Serial No. 14186651.7, filed Sep. 26, 2014, pursuant to 35 U.S.C. 119(a)-(d), the disclosure of which is incorporated herein by reference in its entirety as if fully set forth herein.

### BACKGROUND OF THE INVENTION

The present invention relates to an electrically insulating overload coupling for a wind turbine generator (WTG).

The following discussion of related art is provided to assist the reader in understanding the advantages of the invention, and is not to be construed as an admission that this related art is prior art to this invention.

The Siemens brochure “Reliable connections”, Siemens AG 2011, Order No. E20001-A60-P900-V2-7600, indicates a torsionally rigid all-steel coupling on pages 14 and 15. This coupling of the ARPEX® series, designed especially for WTGs, connects the rapidly moving gear shaft with the generator shaft and usually has the following components: gear-side hub with brake disk, intermediate piece and generator-side hub. The coupling intermediate piece is in such cases generally manufactured from an electrically insulating FRP pipe, which is bonded to the two hubs (FRP=fiber-reinforced plastic). An electrical insulation of the coupling is achieved in this way, which inter alia prevents generator-side leakage currents from resulting in electrical corrosion in the gear toothing.

As overload protection, i.e. as protection of the drive train from a loading beyond its nominal torque, this WTG coupling has a friction coupling in the FRP pipe. The friction coupling includes a friction element with slide linings, e.g. in the form of friction hubs or friction sleeves.

FIG. 1 shows a schematic axial section of a WTG coupling, as described above, in the region of the coupling intermediate piece. As is conventional in mechanical engineering, only a radial half of the section is reproduced in respect of the axis of rotation A. An FRP pipe 300 is connected to a gear-side hub 100 and a generator-side hub 200 in a torsion-resistant manner. The pipe 300 is bonded at its one end on the outside to a gear-side ring element 11 of the gear-side hub 100 and at its opposing end on the outside to a generator side ring element 21 of the generator-side hub 200. The function of a friction coupling embodied in the form of a taper interference fit is hereby integrated only into the gear-side hub 100. An axially arranged ring flange 1200 of a gear-side facing element 12 connected to a rotor is extended radially outwards via a conical clamping ring 500, which is pulled axially toward the facing element 12 by a clamping screw 520, and as a result is pressed in the radial direction from the inside outwards against the gear-side ring element 11. In the case of an overload, a radial outer sliding surface 121 of the ring flange 1200 slips relative to a radial inner sliding surface 111 of the gear-side ring element 11. A defined slipping torque can be produced on account of the stress of the tapered interference fit 500, 1200 and/or a coating of the sliding surfaces 111, 121. The function of such a friction coupling is described for instance in EP 1 693 587 A2 (ATEC-Weiss GmbH & Co. KG; A. Friedr. Flender AG) 23.08.2006.

It would be desirable and advantageous to provide an improved electrically insulating overload coupling for a WTG to obviate prior art shortcomings.

### SUMMARY OF THE INVENTION

According to one aspect of the present invention, an electrically insulating overload coupling for a wind turbine generator includes a gear-side or generator-side hub having an axially oriented ring flange. A pipe made of an electrically insulating material, and having an axial section with an annular circumferential sliding surface rests directly on a corresponding sliding surface of the ring flange, so that the pipe is rotatable in a torque-dependent manner in relation to the ring flange.

The present invention resolves prior art problems by providing the electrically insulating overload coupling with a pipe made of electrically insulating material and a gear-side or generator-side hub. In such cases the hub has an axially oriented ring flange, i.e. a ring flange, the axis of rotation of which runs coaxially with respect to the axis of rotation of the coupling. The pipe has an annularly circumferential sliding surface in an axial section, which rests directly on a corresponding sliding surface of the ring flange. The pipe can be rotated against the ring flange in a torque-dependent manner along the corresponding sliding surfaces.

The axial section of the pipe resting on the ring flange may be a pipe end. It is however also possible for the axial section to lie in a central piece of the pipe, i.e. a section of the pipe which is at a distance from the pipe end.

The ring flange is an annular component, on the inner or outer periphery of which the pipe can be arranged. The ring flange and the pipe are arranged essentially coaxially. The ring flange is a component of a gear-side or generator-side hub, which is connected to a gear shaft or generator shaft in a torsion-resistant manner, e.g. by shrinking, interference fit or a flange connection. The ring flange is thus connected in a torsion-resistant manner to the gear shaft or generator shaft via the hub. In accordance with the invention the overload-dependent rotating function of the overload coupling is shifted to the contact surface of the ring flange and the pipe.

The invention is based on the surprising recognition that a slipping or sliding can take place directly between the pipe, in particular an FRP pipe, and the ring flange, in particular a steel or cast part. Contrary to conventional overload couplings, in which the pipe is connected in a torsion-resistant manner to a ring element of a hub, with which it is in direct contact and a separate friction element with a first and a second friction sleeve is provided as an overload friction unit, wherein in the presence of a torque overload the first friction sleeve slips on the second friction sleeve, in the present invention the pipe itself has a sliding surface, in which it can be rotated relative to a corresponding sliding surface of the ring flange.

Since the pipe itself can be rotated relative to the ring flange, on which it is resting, the need for a separate component, namely a separate friction element, is eliminated compared to conventional overload couplings. As a result of a reduction in the components and processing operations used, the present invention leads to a significant reduction in manufacturing costs compared with previously known approaches.

The sliding surface of the pipe can be treated to achieve a defined sliding effect on the ring flange. The sliding surface has a uniform surface structure, which can be advantageously manufactured using mechanical processing (e.g. milling, turning).

According to another advantageous feature of the present invention, the pipe can be an FRP pipe. The electrical insulation of the FRP material and the high load-bearing capacity, in particular torsion rigidity, of the FRP pipe is advantageous here.

The FRP pipe advantageously can have a following structure: Peripheral layers (radial layers) are wound in order to achieve high rigidity compared with radial deformation. These layers are advantageously wound at an angle of approx. 85° relative to the pipe axis. Moreover, the pipe has the layers required for the torque transmission in an approx. 45° direction.

According to another advantageous feature of the present invention, the FRP pipe can be made of resin and glass fiber content.

The sliding surface of the ring flange can be treated as follows in order to achieve a defined sliding effect against the pipe. The sliding surface has a surface structure which is advantageously manufactured by mechanical processing (e.g. milling, turning). The roughness of the sliding surface is in a range of up to Ra=6.3 μm or Rz=10 μm (Ra average roughness; Rz=averaged depth of roughness). The ring flange can advantageously have a concentricity property of tolerance class 7 which is known in the art.

According to another advantageous feature of the present invention, the ring flange can be made of a metallic material, in particular of steel or a cast material such as cast iron. As a result, the ring flange can be manufactured in a stable and cost-effective manner.

The ring flange has advantageously a following structure: A cylindrical, multiple cylindrical or conical surface is made available as the sliding surface. This is processed mechanically as described above. Moreover, the ring flange may include a number of boreholes for screws or adapter screws for connection with further components. Similarly, further form-fit connections, such as feather keys, synchronization gearing or spiral toothing, are conceivable.

According to another advantageous feature of the present invention, the ring flange can be made of steel or cast material.

Advantageously, the sliding surface is wetted uniformly by a lubricating paste in order to achieve as “stick-slip-free” a sliding as possible.

According to another advantageous feature of the present invention, the pipe can rest radially on an outside of the ring flange. Advantageously, an annular surface required in conventional overload couplings for bonded connection between the pipe and a ring element can hereby be used directly as a friction surface.

According to another advantageous feature of the present invention, the pipe can rest radially on an inside of the ring flange. Advantageously, an annular surface required in conventional overload couplings for bonded connection between the pipe and a ring element can hereby be used directly as a friction surface.

According to another advantageous feature of the present invention, the coupling can have a clamping element which is configured to radially deform the ring flange and thereby clamp the ring flange radially against the pipe. The clamping element may have the form of a conical ring with a conical surface which can be displaced in the axial direction in relation to the ring flange. Advantageously, the ring flange and the clamping element each can have a conical surface, along which the two components are displaced in relation to one another. The relative displacement of the clamping element and the ring flange causes a radial deformation of the ring flange. It is advantageous hereby that the radial deformation can be defined precisely by the clamping element of the ring flange and thus the bracing of the pipe and ring flange and consequently the torque when sliding occurs.

According to another advantageous feature of the present invention, the clamping element can be arranged radially within the ring flange such that the ring flange can be expanded radially. This is advantageous because the FRP pipe only has to be manufactured accurately from the inside. The outer pipe surface does not need to be refinished later and can thus remain in a raw state (winding).

According to another advantageous feature of the present invention, the clamping element can be arranged radially outside of the ring flange such that the ring flange can be constricted radially. This is advantageous because the FRP pipe only has to be manufactured accurately from the outside. The inner pipe surface does not need to be refinished later and can thus remain in the raw state (winding).

According to another advantageous feature of the present invention the pipe can be arranged radially between the ring flange and a bearing ring. The presence of the bearing ring is advantageous because the required pressure for torque transmission, which is exerted by the ring flange onto the pipe, can be increased without the FRP pipe expanding beyond the permissible limits. The bearing ring attached to the peripheral surface of the pipe facing away from the ring flange counteracts a radial pressure exerted on the pipe by the ring flange and prevents the pipe from impermissibly widening. Depending on the arrangement of the ring flange relative to the pipe, i.e. resting on the outside or the inside, the bearing ring can be placed over the inner or outer periphery of the pipe.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic axial section of a conventional WTG coupling;

FIG. 2 is an axial section of a first embodiment of an overload coupling according to the present invention, depicting a pipe resting radially from outside on a ring flange;

FIG. 3 is an axial section of a second embodiment of an overload coupling according to the present invention, depicting a pipe resting radially from inside on a ring flange;

FIG. 4 is an axial section of a third embodiment of an overload coupling according to the present invention, similar to FIG. 2 but with provision of an additional bearing ring;

FIG. 5 is an axial section of a fourth embodiment of an overload coupling according to the present invention, similar to the overload coupling of FIG. 3 but with provision of an additional bearing ring;

FIG. 6 is an axial section of a fifth embodiment of an overload coupling according to the present invention, depicting a pipe resting radially from inside on the ring flange and a clamping element for expanding a ring flange radially from the inside;

FIG. 7 is an axial section of a sixth embodiment of an overload coupling according to the present invention, depicting a pipe resting radially from inside on the ring flange and a clamping element for expanding a ring flange radially from the outside;

FIG. 8 is an axial section of a seventh embodiment of an overload coupling according to the present invention, similar to the overload coupling FIG. 6 but with provision of an additional bearing ring; and

FIG. 9 is an axial section of an eighth embodiment of an overload coupling according to the present invention, similar to the overload coupling FIG. 7 but with provision of an additional bearing ring.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

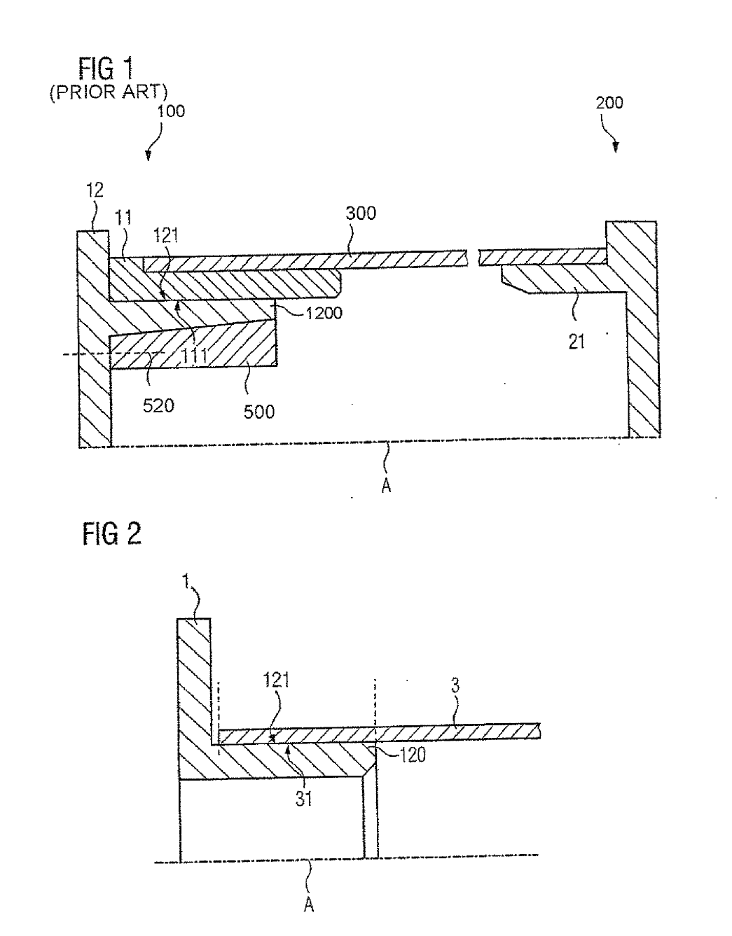

Turning now to the drawing, and in particular to FIG. 2, there is shown an axial section of a first embodiment of an overload coupling according to the present invention. The overload coupling includes a pipe 3 which rests radially from outside on a ring flange 120 of a gear-side hub 1 and a generator-side hub (only gear-side hub 1 is shown here by way of example). It will be understood by persons skilled in the art that a description of the gear-side hub 1 is equally applicable to the generator-side hub so that in the following description any reference to a “hub” is to be understood in a generic sense, and the hub can be a gear-side hub 1 or a generator-side hub of a WTG coupling.

A ring flange 120 is connected in a rotationally fixed manner to the remaining components of the gear-side hub 1 and the generator-side hub. The pipe 3 has a sliding surface 31, which is embodied on the inner periphery of the pipe 3 and rests on a corresponding sliding surface 121 of the ring flange 120, which sliding surface 121 is embodied on the outer periphery of the ring flange 120. Assembly of the pipe 3 on the ring flange 120 takes place by the pipe 3 being pressed onto the ring flange 120 using press fitting. The pipe 3 as a result expands within permissible limits.

The sliding surfaces 121, 31, the axial length of which is indicated by the vertically running dashed lines in FIG. 2, are pressed against one another with a specific force by the press fit so that a defined friction force acts there between. When the torque acting between the gear-side hub 1 and the generator-side hub and the pipe 3 exceeds the friction force between the sliding surfaces 31, 121, the pipe 3 and the ring flange 120 rotate relative to one another, as the sliding surfaces 121, 31 slide on one another.

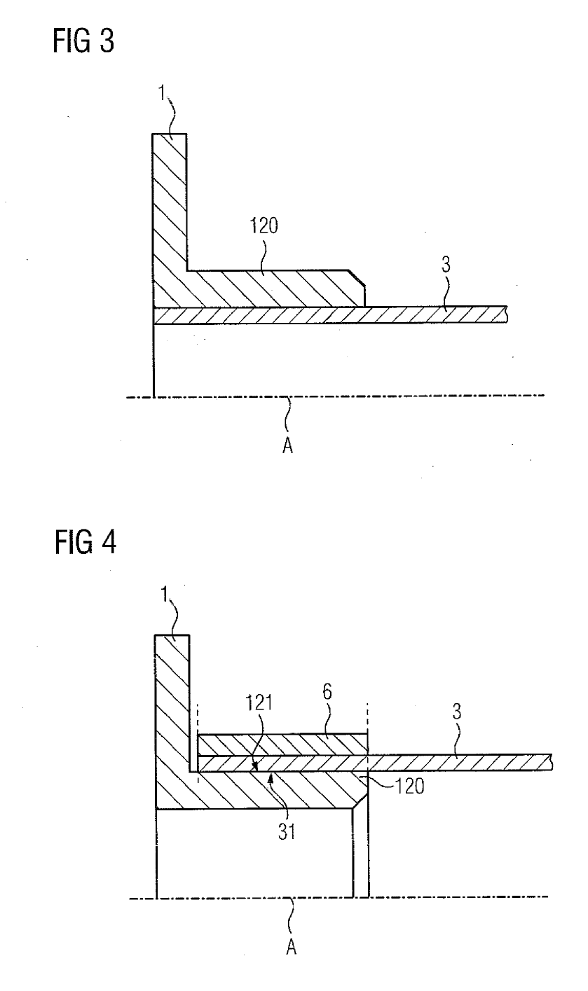

FIG. 3 shows an axial section of a second embodiment of an overload coupling according to the present invention. Parts corresponding with those in FIG. 2 are denoted by identical reference numerals and not explained again. In this embodiment, the pipe 3 rests radially from inside upon the ring flange 120. The ring flange 120 is comparable to that in FIG. 2. The difference between the embodiment variants in FIG. 2, in which the pipe 3 touches the ring flange 120 radially from the outside, resides in that the pipe 3 rests here radially from the inside on the ring flange 120. Assembly of the pipe 3 in the ring flange 120 is realized by pressing the pipe 3 into the ring flange 120 using press fitting. As a result the pipe 3 expands within permissible limits.

FIG. 4 shows an axial section of a third embodiment of an overload coupling according to the present invention which is similar to the axial section shown in FIG. 2. Parts corresponding with those in FIG. 2 are denoted by identical reference numerals and not explained again. The description below will center on the differences between the embodiments. In the embodiment of FIG. 4, the pipe 3 in the axial section of the sliding surfaces bears a bearing ring 6 on its outer periphery. The bearing ring 6 counteracts the pressure exerted by the ring flange 120 radially from the inside onto the pipe 3 and prevents the pipe 3 from impermissibly wide expansion. Assembly of the combination of pipe 3, ring flange 120 and bearing ring 6 is realized by initially moving the bearing ring 6 over the pipe 3. Then the pipe 3 is pressed with press fitting onto the ring flange 120, with the bearing ring 6 resting thereupon. The pipe 3 then expands within the limits predetermined by the bearing ring 6.

FIG. 5 shows an axial section of a fourth embodiment of an overload coupling according to the present invention which is similar to the axial section shown in FIG. 3. Parts corresponding with those in FIG. 3 are denoted by identical reference numerals and not explained again. The description below will center on the differences between the embodiments. In the embodiment of FIG. 5, the pipe 3 in the axial section of the sliding surfaces bears a bearing ring 6 on its outer periphery. The bearing ring 6 counteracts the pressure exerted by the ring flange 120 radially from the inside onto the pipe 3 and prevents the pipe 3 from an impermissibly large radial constriction or squashing. Assembly of the combination of pipe 3, ring flange 120 and bearing ring 6 is realized by initially moving the bearing ring 6 into the pipe 3. Then the pipe 3 is pressed with press fitting into the ring flange 120 with the bearing ring 6 resting thereupon. The pipe 3 then constricts within the limits predetermined by the bearing ring 6.

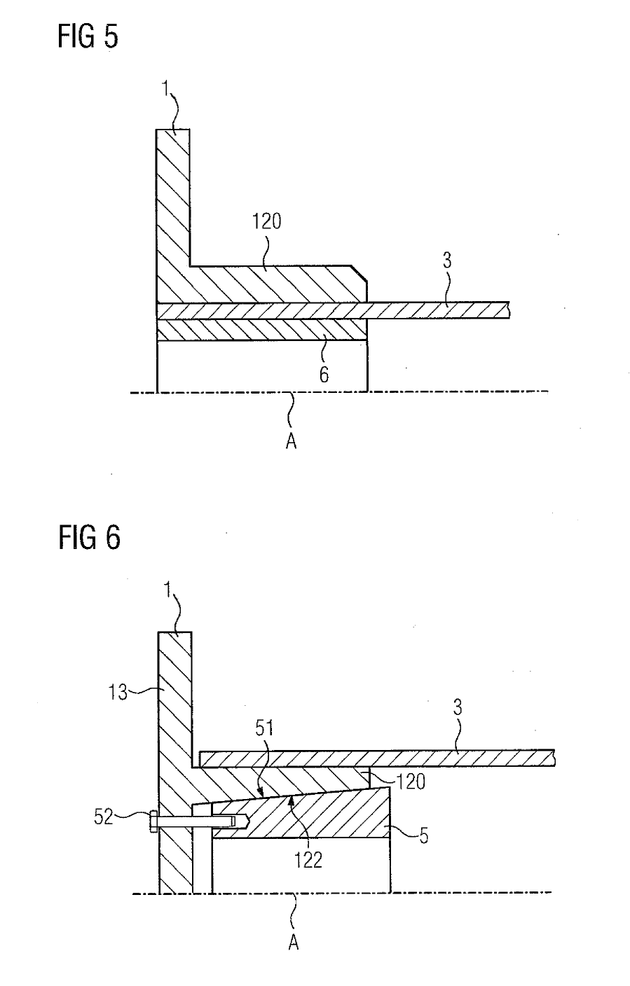

FIG. 6 shows an axial section of a fifth embodiment of an overload coupling according to the present invention. Parts corresponding with those in FIG. 2 are denoted by identical reference numerals and not explained again. In the embodiment of FIG. 6, the pipe 3 rests radially from the outside on the ring flange 120 and an annular clamping element 5 expands the ring flange 120 radially from the inside. The clamping element 5 has the form of a conical ring and has a radial surface 51, which points outwards and expands conically. The peripheral surface 122 of the ring flange 120 pointing toward the clamping element 5 is embodied counter-directionally conically to the clamping element 5. The ring flange 120 and the clamping element 5 can be displaced axially relative to one another along their two conical surfaces 51, 122. The relative displacement can take place in that the clamping element 5 is pulled in the direction of a facing element 13 of the hub 1 by a clamping screw 52. The relative displacement causes a radial deformation of the ring flange 120. On account of the length of the axial displacement, this deformation and thus the bracing of the ring flange 120 can be adjusted against the FRP pipe 3.

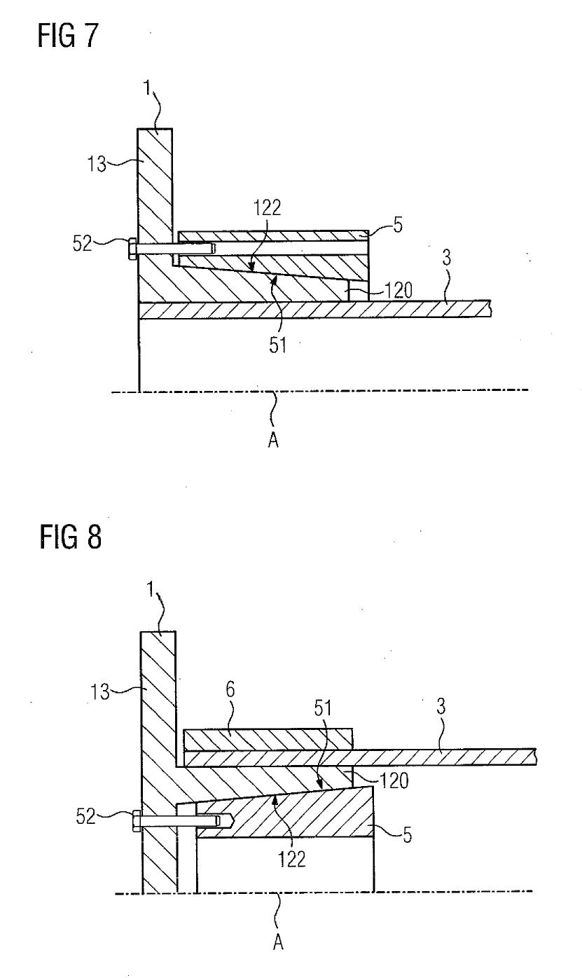

FIG. 7 shows an axial section of a sixth embodiment of an overload coupling according to the present invention. Parts corresponding with those in FIG. 2 are denoted by identical reference numerals and not explained again. In the embodiment of FIG. 7, the pipe 3 rests radially from the inside on the ring flange 120 and a clamping element 5 constricts the flange 120 radially from the outside. The difference between the embodiments of FIGS. 6 and 7 resides only in that the ring flange 4 is not radially expanded, but instead radially constricted, i.e. squashed. Otherwise, the description with respect to the overload coupling of FIG. 6 applies also to the overload coupling of FIG. 7.

FIG. 8 shows an axial section of a seventh embodiment of an overload coupling according to the present invention which is similar to the axial section shown in FIG. 6. Parts corresponding with those in FIG. 6 are denoted by identical reference numerals and not explained again. The description below will center on the differences between the embodiments. In the embodiment of FIG. 8, the pipe 3 in the axial section of the sliding surfaces bears a bearing ring 6 on its outer periphery. The bearing ring 6 counteracts the pressure exerted by the ring flange 120 radially from the inside onto the pipe 3 and prevents the pipe 3 from an impermissibly wide expansion.

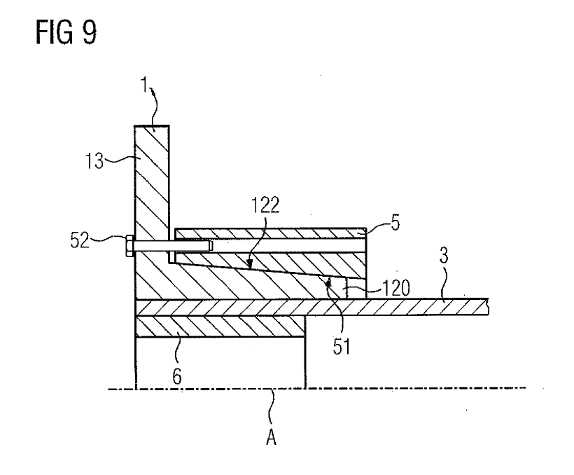

FIG. 9 shows an axial section of an eight embodiment of an overload coupling according to the present invention which is similar to the axial section shown in FIG. 7. Parts corresponding with those in FIG. 7 are denoted by identical reference numerals and not explained again. The description below will center on the differences between the embodiments. In the embodiment of FIG. 9, the pipe 3 in the axial section of the sliding surfaces bears a bearing ring 6 on its inner periphery. The bearing ring 6 counteracts the pressure exerted by the ring flange 120 radially from the outside onto the pipe 3 and prevents the pipe 3 from an impermissibly large radial constriction or squashing.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An electrically insulating overload coupling for a wind turbine generator, said overload coupling comprising:
a gear-side or generator-side hub including an axially oriented ring flange; and
a pipe made of an electrically insulating material and having an axial section with an annular circumferential sliding surface which rests directly on a corresponding sliding surface of the ring flange, so that the pipe is rotatable in a torque-dependent manner in relation to the ring flange.

2. The overload coupling of claim 1, wherein the pipe is an FRP (fiber-reinforced plastic) pipe.

3. The overload coupling of claim 2, wherein the FRP pipe is made of wound peripheral layers (radial layers).

4. The overload coupling of claim 3, wherein the layers are wound at an angle of approx. 85° relative to a pipe axis.

5. The overload coupling of claim 2, wherein the FRP pipe is made of resin and glass fiber content

6. The overload coupling of claim 1, wherein the ring flange is made of metallic material.

7. The overload coupling of claim 1, wherein the ring flange is made of steel or cast material.

8. The overload coupling of claim 1, wherein the pipe rests radially on an outside of the ring flange.

9. The overload coupling of claim 1, wherein the pipe rests radially on an inside of the ring flange.

10. The overload coupling of claim 1, further comprising a clamping element configured to deform the ring flange and thereby clamp the ring flange radially against the pipe.

11. The overload coupling of claim 10, wherein the clamping element is in the form of a conical ring.

12. The overload coupling of claim 11, wherein the clamping element and the ring flange have complementing conical surfaces to enable a displacement of the clamping element and the ring flange in relation to one another.

13. The overload coupling of claim 10, wherein the clamping element is arranged radially within the ring flange to be able to expand the ring flange radially.

14. The overload coupling of claim 10, wherein the clamping element is arranged radially outside of the ring flange to constrict the ring flange radially.

15. The overload coupling of claim 1, further comprising a bearing ring, said pipe being arranged radially between the ring flange and the bearing ring.

16. The overload coupling of claim 10, wherein the sliding surface of the ring flange has a surface structure with a roughness in a range of up to Ra=6.3 μm or Rz=10 μm, wherein Ra is an average roughness, and Rz is an averaged depth of roughness.
